(19) United States
(12) Patent Application Publication
(10) Pub. No.: US 2002/0075459 A1
(43) Pub. Date: Jun. 20, 2002

(54) Projection displaying system

(76) Inventor: Ching-Chung Lin, Taipei Hsien (TW)

Correspondence Address: BACON & THOMAS, 4th Floor, 625 Slaters Lane, Alexandria, VA, 22314, US

(21) Appl. No.: 09/736,211

(22) Filed: Dec. 15, 2000

(51) Int. Cl. G03B 21/22

(52) U.S. Cl. 353/74

(57) ABSTRACT

A projection displaying system comprises a housing having a screen and control panel mounted thereof. The housing further includes a projector, an electronic processor and a reflecting mirror, wherein images from the projector are projected to the screen via the reflecting mirror by maneuvering controlling buttons on the panel or a remote control. Characterized in that the housing includes a receiving chamber in which an inclined positioning bracket and a second reflecting mirror are disposed therein. Wherein the images from the projector can be readily adjusted by adjusting positions of the positioning bracket such that sharp images can be projected to the reflecting mirror.

### FIELD OF THE INVENTION

The present invention relates to a projection displaying system, and more particularly to a projection displaying system having a projector cartridge such that projectors from different makers can be readily incorporated in the projection displaying system.

### DESCRIPTION OF THE PRIOR ART

The existing projection displaying system can be categorized into forward projection displaying system, and rearward projection displaying system. The forward projection displaying system can be further divided into portable and stationary systems and which are used for business promotion and brief. The rearward projection displaying system is generally used with audio and video processing system to serve as television with large screen and which is called projection television. The projection television generally includes a housing with a projector disposed therein. When the audio image is input into the projector, the image is projected to a reflective mirror and the reflected and enlarged image can be seen from a screen of the projection television.

However, the projection television can only be used as an entertaining apparatus and has no other flexible applications because it is too heavy and bulky to move from one place to another.

### SUMMARY OF THE INVENTION

It is an objective of this invention to provide a projection displaying system in which a receiving chamber is provided to receive a projector from different makers therein.

It is still an objective of this invention to provide a projection displaying system in which the projector can be readily removed from the receiving chamber for using as a projector.

In order to achieve the objective set forth, a projection displaying system in accordance with the present invention comprises a housing having a screen and control panel mounted thereof. The housing further includes a projector, an electronic processor and a reflecting mirror, wherein images from the projector are projected to the screen via the reflecting mirror by maneuvering controlling buttons on the panel or a remote control. Characterized in that the housing includes a receiving chamber in which an inclined positioning bracket and a second reflecting mirror is disposed therein. Wherein the images from the projector can be readily adjusted by adjusting positions of the positioning bracket such that sharp images can be projected to the reflecting mirror.

### BRIEF DESCRIPTION OF PREFERRED EMBODIMENT

Other objects and advantages of the present invention will become apparent from the following detailed description of the preferred embodiments thereof taken in conjunction with the accompanying drawings wherein:

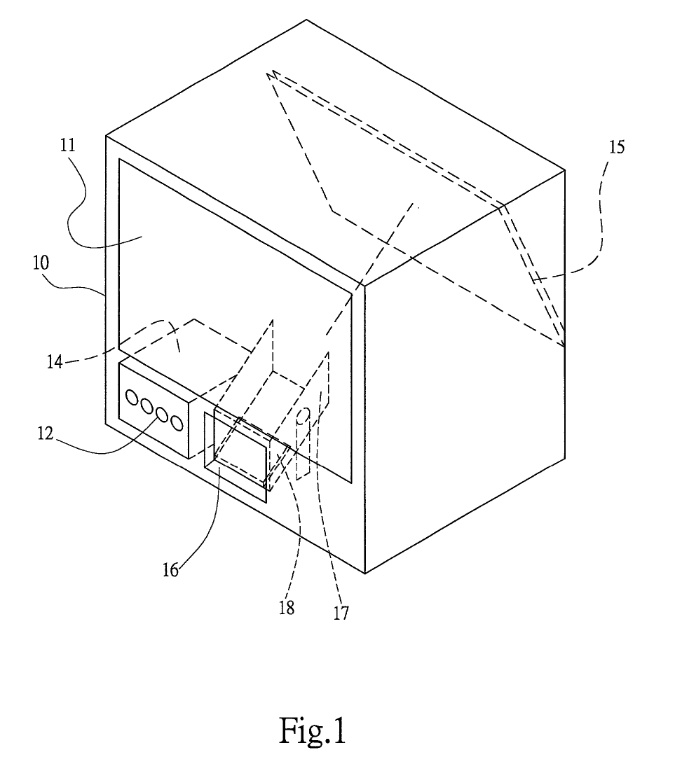

FIG. 1 is a perspective view of a projection displaying system in accordance with the present invention;

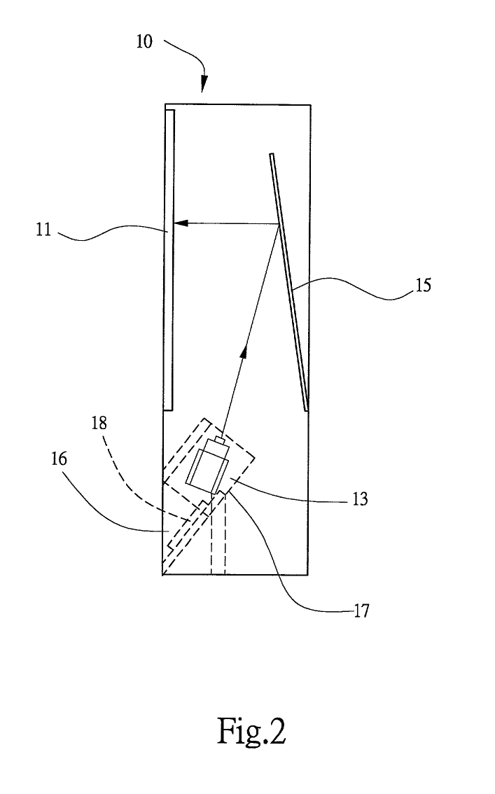

FIG. 2 is a side illustration view showing a first reflection between a screen and a projector;

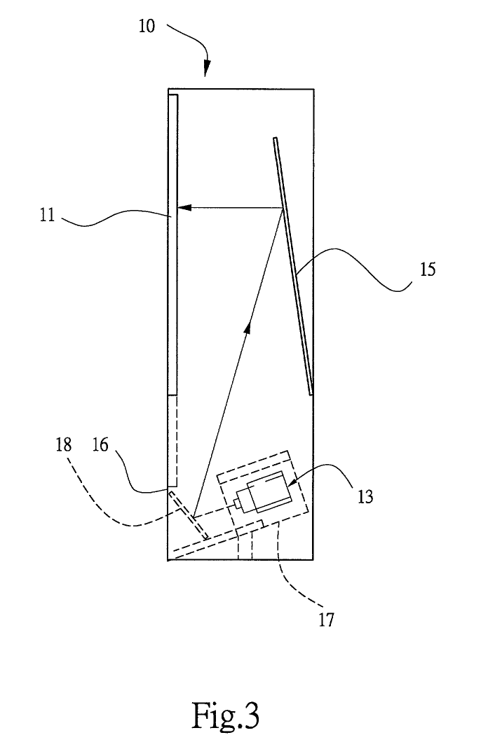

FIG. 3 is a side illustration view showing a second reflection between a screen and a projector;

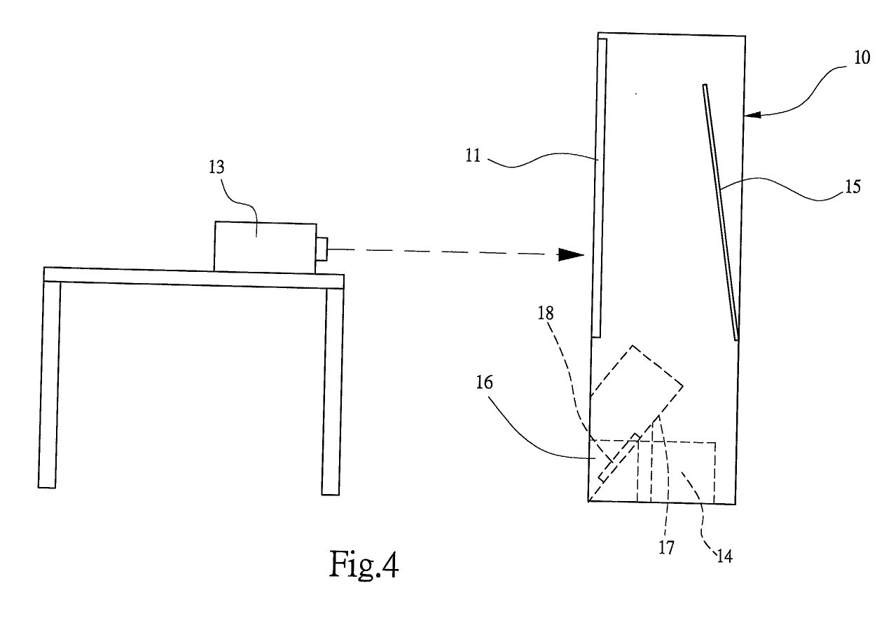

FIG. 4 is an illustration showing an application of the projector; and

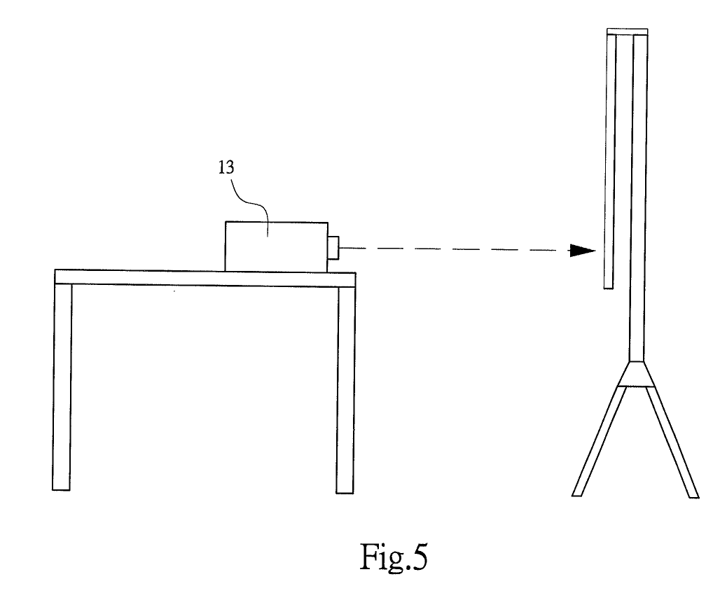

FIG. 5 is another illustration showing another application of the present invention.

### DETAILED DESCRIPTION OF PREFERRED EMBODIMENT

Referring to FIGS. 1 to 3, a projection displaying system in accordance with the present invention comprises a housing 10 having a screen 11 and control panel 12 mounted thereof. The housing further includes a projector 13, an electronic processor 14 and a reflecting mirror 15. Images from the projector 14 are projected to the screen 11 via the reflecting mirror 15 by maneuvering controlling buttons on the panel of the control panel 12 or a remote control. Characterized in that the housing 10 includes a receiving chamber 16 adjacent to the control panel 12 and in which an inclined positioning bracket 17 and a second reflecting mirror 18 are disposed therein. By this arrangement, the projector 13 from any maker can be disposed therein. Furthermore, the images from the projector 13 can be readily adjusted by adjusting the projecting angle, height, distance and the positions of the positioning bracket 17 such that sharp images can be projected to the reflecting mirror 18. In addition, the first reflecting mirror 15, and the second reflecting mirror 15 can also be adjusted to reach sharp images on the screen 11. By the way, the projector 13 can be removed from the receiving chamber 16 for use as a single projector.

According to an embodiment of the present invention, a lid (not shown) can be arranged to the receiving chamber 16 and which serves as a dust protector. In addition, it may also increase the overall aesthetic appearance. As shown in FIG. 4, when the projector 13 is removed from the receiving chamber 16, the projector 13 can be connected to a connector of the housing 10 by extension cord, and the projector 13 can be used as a forward projector 13 together with the electronic processor 14. On the other hand, the projector 13 can also be installed to a desired place for briefing and promotion, such as shown in FIG. 5. Accordingly, the projector 13 can be used along or used with the projection displaying system.

While specific illustrated embodiments have been shown and described, it will be appreciated by those skilled in the-art that various modifications, changes, and additions can be made to the invention without departing from the spirit and scope thereof as set forth in the following claims.

I claim:

1. A projection displaying system, comprising a housing having a screen and control panel mounted thereof, said housing further including a projector, an electronic processor and a reflecting mirror, wherein images from said projector are projected to said screen via said reflecting mirror by maneuvering controlling buttons on said panel or a remote control, characterized in that:
said housing including a receiving chamber in which said projector is removeably disposed therein such that images from aid projector can be projected to said screen via said reflecting mirror, while said projector can be easily removed therefrom.

2. The projection displaying system as recited in claim 1, wherein said receiving chamber includes an inclined positioning bracket and a second reflecting mirror, wherein said images from said projector can be readily adjusted by adjusting said positioning bracket such that sharp images can be projected to said reflecting mirror.

3. The projection displaying system as recited in claim 2, wherein said receiving chamber is covered by a lid.

4. The projection displaying system as recited in claim 3, wherein said projector can be removed from said receiving chamber and directly used as a projector.
